(19) United States
(12) Patent Application Publication
(10) Pub. No.: US 2005/0179626 A1
(43) Pub. Date: Aug. 18, 2005

(54) Drive circuit and image forming apparatus using the same

(75) Inventors: Osamu Yuki, Tokyo (JP); Yoshinori Nakajima, Yokohama-Shi (JP); Shigeki Kondo, Hiratsuka-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/045,109

(22) Filed: Jan. 31, 2005

(30) Foreign Application Priority Data
Feb. 12, 2004 (JP) 2004-035295

(51) Int. Cl. G09G 3/30

(52) U.S. Cl. 345/76

(57) ABSTRACT

In a pixel circuit that accumulates a display signal Vsig in a capacitor and supplies a display current to a light-emitting element using a TFT serving as a drive transistor in order to correct fall of a luminance due to aged deterioration of the light-emitting element, the pixel circuit supplies the display current to a gate of a TFT and sets a source of the TFT to a value obtained by deducting a threshold value of the TFT from an anode potential of the light-emitting element with respect to the display current using a variable bias voltage to thereby extract an amount of an increase of a voltage due to the aged deterioration of the light-emitting element as a source-to-drain current of the TFT. The pixel circuit feeds the source-to-drain current from the capacitor as a correction signal and adjusts a gate potential of the TFT serving as the drive transistor to thereby correct the display current and correct a luminance of the light-emitting element.

### BACKGROUND OF THE INVENTION

1. Field of the Invention

The present invention relates to a drive circuit for a load that can be used in image forming apparatuses represented by a television receiver, a digital camera, a digital video camera recorder, a monitor of a computer, a printer of an electrophotographic system, and the like. More specifically, the invention relates to a drive circuit for a light-emitting element that can be used in a display and an exposing device that use a light-emitting element as a load.

2. Related Background Art

As an example of a load, a light-emitting element, in particular, an organic EL (electroluminescent) element is a planar selfluminous element of stacked thin film layers that is capable of emitting light at a high luminance. This EL element makes it possible to emit light at a low voltage and high efficiency by increasing the number of functional stacked layers of organic layers (see “Applied Physics Letters” Vol. 51, 1987, 913 and “Journal of Applied Physics” Vol. 65, 1989, 3610). Since the organic EL element can obtain substantially linear light-emitting intensity with respect to an electric current, a constant current drive method has been proposed.

FIG. 8 shows an example of a circuit structure of one pixel of a display element using the conventional EL element. In the figure, reference numerals 1, 3 and 4 denote thin film transistors (TFT); 2, a capacitor; 5, an EL element; 6, an ammeter; and 7, a power supply. An operation of the circuit will be explained with reference to a timing chart of FIG. 9.

In a predetermined writing period, a source potential Vsig of the n-type TFT 1 is set to a display signal corresponding to a luminance of display of the pixel in the next frame, a gate potential Vg1 of the TFT 1 rises to H (high level) at time t1 at which the signal is decided as shown in FIG. 9, and the TFT 1 is turned ON, whereby a charge corresponding to the display signal is accumulated in the capacitor 2. Subsequently, Vg1 falls to L (low level) at t2 and the TFT 1 turns OFF again and, at the same time, a gate voltage Vg2 of the n-type TFT 4 rises to H and the TFT 4 is turned ON. Thus, an electric current (display current) corresponding to the charge accumulated in the capacitor 2 flows to the TFT 3 to be supplied to the EL element 5, whereby the EL element 5 emits light at a luminance corresponding to the display signal until the next writing is performed. Reference numeral 6 denotes an ammeter, which is unnecessary for an actual drive circuit but is illustrated here for the explanation of an operation.

However, it is known that, even if the organic EL element emits light at a constant current, an impedance changes due to deterioration of stacked organic layers and a luminance falls with time as shown in FIG. 10. FIG. 10 shows a rough tendency, and actual aged deterioration of characteristics of the organic EL element is not limited to the figure.

Thus, a method of measuring a drive time to change a luminance and a method of detecting a luminance with a sensor to adjust a drive voltage have been proposed (see Japanese Patent Application Laid-Open No. S59-055487).

Japanese Patent Application Laid-Open No. S59-055487, “Applied Physics Letters” Vol. 51, 1987, 913, and “Journal of Applied Physics” Vol. 65, 1989, 3610 propose methods for coping with the fall in a luminance due to deterioration of the organic EL element. However, according to these proposals, the methods require means for storing a drive time and a sensor, and it is difficult to compensate for a change in a luminance by a unit of frame for each pixel.

### SUMMARY OF THE INVENTION

It is an object of the invention to provide a drive circuit that can drive a load stably for a long period of time even if the load deteriorates with time to cause changes in an impedance and a resistance and an image forming apparatus using the drive circuit.

It is another object of the invention to, even in the case in which a load is a light-emitting element having a characteristic of deteriorating with time, realize stable image formation for a long period of time by detecting a fall in a luminance due to aged deterioration of the light-emitting element for each pixel and correcting (compensating for) the fall in a luminance.

A first drive circuit of the invention includes a drive transistor for feeding a drive current corresponding to an input signal to a load, and the drive circuit has a correction circuit that supplies a correction signal corresponding to an impedance of the load to a gate of the drive transistor to correct the drive current to be fed to the load by the drive transistor.

Preferably, the load is a light-emitting element, and the drive circuit feeds an electric current to the light-emitting element, detects a voltage between both terminals of the light-emitting element to detect an impedance of the light-emitting element, and performs the correction on the basis of a result of the detection.

In addition, preferably, the load is a light-emitting element, one terminal of the light-emitting element is connected to a gate of a transistor for correction, and when a predetermined potential Ps is set to a value calculated by deducting a threshold voltage Vth of the transistor for correction from a terminal potential Pi of the light-emitting element with respect to a drive current, the drive circuit sets a source potential of the transistor for correction to the predetermined potential Ps to thereby generate a voltage corresponding to an impedance of the light-emitting element as a source-to-drain current of the transistor for correction.

Preferably, the drive circuit inputs the source-to-drain current of the transistor for correction to the gate of the drive transistor as the correction signal.

Preferably, the drive circuit sets the source potential of the transistor for correction using a nonlinear element having a variable bias voltage or diode characteristic.

Preferably, it is possible to multiply the correction signal with a coefficient according to a setting for a size of the transistor for correction.

An image forming apparatus of the invention includes a pixel circuit group in which plural pixel circuits, which include a light-emitting element and a drive transistor for feeding a drive current corresponding to an input signal to the light-emitting element, are arranged, and each of the pixel circuits has a correction circuit that supplies a correction signal corresponding to an impedance of a load to a gate of the drive transistor and corrects the drive current to be fed to the light-emitting element by the drive transistor.

Preferably, the light-emitting element is an organic electroluminescent element.

In addition, preferably, the pixel circuit group is arranged in a two-dimensional matrix shape, and the image forming apparatus includes: a display unit that forms an image in the pixel circuit group according to light emission of the light-emitting element; a line drive circuit that supplies an image signal to the pixel circuit group; an image data supply circuit that supplies image data to the line drive circuit; and a decoder that decodes compressed image data stored in a storage medium and supplies the decoded image data to the image data supply circuit.

Preferably, the image forming apparatus includes: a photosensitive member; an exposure device that has the pixel circuit group arranged at least in a one-dimensional matrix shape and is used for forming a latent image on the photosensitive member according to light emission of the light-emitting element; a developing device; a line drive circuit that supplies an image signal to the pixel circuit group; and an image data supply circuit that supplies image data to the line drive circuit.

Another drive circuit of the invention includes a drive transistor for feeding a drive current corresponding to an input signal to a load, and the drive circuit has a correction circuit that supplies a correction signal corresponding to an amount of deterioration of the load to a gate of the drive transistor to correct the drive current to be fed to the load by the drive transistor.

Still another drive circuit of the invention includes: a drive transistor for feeding a drive current corresponding to an input signal to a load; a storage capacitor that is connected to a control electrode of the drive transistor and used for retaining an input signal; a detection circuit for detecting a resistance of the load; and a correction circuit that feeds back a result of the detection by the detection circuit to the drive transistor to correct a drive current to be fed to the load by the drive transistor.

Preferably, the detection circuit includes a second capacitor that is connected to a terminal, which is connected to the load, via a switching transistor, and the correction circuit includes a transistor for correction that has a control electrode connected to the second capacitor and is used for changing a potential of the control electrode of the drive transistor.

An image forming apparatus of the invention is an image forming apparatus including a pixel circuit group in which plural pixel circuits, which include a light-emitting element serving as a load and the drive circuit according described above, are arranged. In the image forming apparatus, preferably, the pixel circuit group is arranged in a two-dimensional matrix shape, and the image forming apparatus includes: a display unit that forms an image in the pixel circuit group according to light emission of the light-emitting element; a line drive circuit that supplies an image signal to the pixel circuit group; an image data supply circuit that supplies image data to the line drive circuit; and a decoder that decodes compressed image data stored in a storage medium and supplies the decoded image data to the image data supply circuit.

An image forming apparatus of the invention is an image forming apparatus including a pixel circuit group in which plural pixel circuits, which include a light-emitting element serving as a load and the drive circuit described above, are arranged. Preferably, the image forming apparatus includes: a photosensitive member; a charging device for charging a photosensitive member; an exposing device that has the pixel circuit group arranged at least in a one-dimensional matrix shape and is used for forming a latent image on a photosensitive member according to light emission of the light-emitting element; a developing device; a line drive circuit that supplies an image signal to the pixel circuit group; and an image data supply circuit that supplies image data to the line drive circuit.

According to the invention, even if a load deteriorates with time to cause changes in an impedance and a resistance, feedback provides stable drive over a long period of time.

For example, in the case in which a light-emitting element having a characteristic of deteriorating with time to have a low luminance is used as a load, it is possible to perform correction of a luminance by a unit of frame for each pixel. Thus, the aged deterioration of the light-emitting element does not affect an image, and it is possible to display a stable image for a long period of time. Consequently, the present invention is used in an image forming apparatus like a display and an image forming apparatus of the electrophotographic system suitably.

### BRIEF DESCRIPTION OF THE DRAWINGS

FIG. 1 is a pixel circuit diagram of an embodiment of the invention;

FIG. 2 is a timing chart of an operation of a circuit in FIG. 1;

FIG. 3 is a pixel circuit diagram of another embodiment of the invention;

FIG. 4 is a pixel circuit diagram of another embodiment of the invention;

FIG. 5 is a timing chart of an operation of a circuit in FIG. 4;

FIG. 6 is a circuit diagram for explaining a basic principle of the invention;

FIG. 7 is a voltage characteristic chart in a circuit in FIG. 6;

FIG. 8 is a pixel circuit diagram of a conventional display element;

FIG. 9 is a timing chart of an operation of a circuit in FIG. 8;

FIG. 10 is a diagram showing aged deterioration of a light-emitting element of the circuit in FIG. 8;

FIG. 11 is a diagram showing a current correction circuit manufactured on trial; and

FIG. 12 is a diagram showing a characteristic of the circuit in FIG. 11.

### DESCRIPTION OF THE PREFERRED EMBODIMENTS

First, in order to facilitate understanding of an operation of a drive circuit of the invention, a basic operation will be explained with reference to the accompanying drawings.

In a circuit shown in FIG. 8, a luminance of a light-emitting element 5 serving as a load, to which a predetermined electric current is supplied, falls with time as shown in FIG. 10, and a voltage between both terminals of the light-emitting element 5 rises. This is because an impedance of the light-emitting element 5 rises due to deterioration of organic layers of the light-emitting element 5. In an embodiment of the invention, the voltage rise at this point is detected as an amount of impedance change in the light-emitting element 5 and the amount of impedance change is fed back to a TFT 3 serving as a drive transistor to adjust an amount of an electric current to be supplied to the light-emitting element 5 by the TFT 3, whereby an electric current flowing to the light-emitting element 5 is corrected to correct a luminance of the light-emitting element 5.

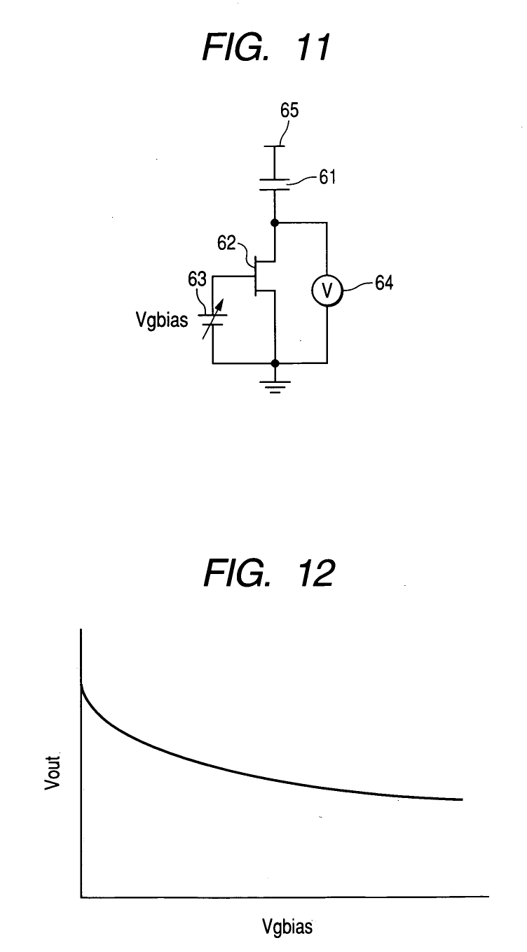

As shown in FIG. 10, a voltage change draws a curved line. On the other hand, a luminance change draws a curved line of a curve substantially opposite to a curve of a voltage rise. A circuit shown in FIG. 11 is manufactured on trial. In the figure, reference numeral 61 denotes a capacitor; 62, a TFT; 63, a variable bias voltage; and 64, a voltmeter. The TFT 62 is an n-channel type TFT. As a potential of a control terminal of the TFT 62 provided on a common side of the capacitor 61, a variable bias voltage Vgbias is changed by the variable bias voltage 63 in a range from a threshold value of the TFT 61 to a working current value. As a result, a source-to-drain voltage of the TFT 62 shows a characteristic shown in FIG. 12. The characteristic is opposite to a source-to-drain current characteristic of a p-type TFT 3 in FIG. 8. A voltage of the capacitor 61 is proportional to an amount of charge. In other words, the voltage is proportional to a conducting time of the source-to-drain current of the TFT 62. Therefore, if the circuit in FIG. 11 is incorporated in the circuit in FIG. 8 to use the source-to-drain voltage of the TFT 62 as a gate voltage of the TFT 11 of the circuit in FIG. 8, the fall of luminance of the light-emitting element 13 could be compensated linearly by applying a voltage, which changes substantially linearly, to the control terminal of the TFT 62.

Here, as the load that can be used in the present invention, there are an LED formed of an inorganic material, an LED formed of an organic material (this is often called an organic EL), an electron-emitting element, a light-emitting element formed of an electron-emitting element and a phosphor, and the like. In particular, a light-emitting element, which can adjust a luminance according to a current value, is appropriate.

As a transistor used in the invention, an insulated gate transistor, more specifically, an MOS transistor using bulk silicon may be used. However, a thin film transistor (TFT) having a semiconductor layer on an insulating surface of a substrate is preferably used. As the TFT, any of a TFT using a so-called amorphous semiconductor, a TFT using a polycrystal semiconductor, and a TFT using a monocrystal semiconductor may be used. However, the TFT using a polycrystal semiconductor, in particular, a low-temperature polysilicon TFT is used appropriately.

A specific example of a circuit structure will be explained.

### First Embodiment

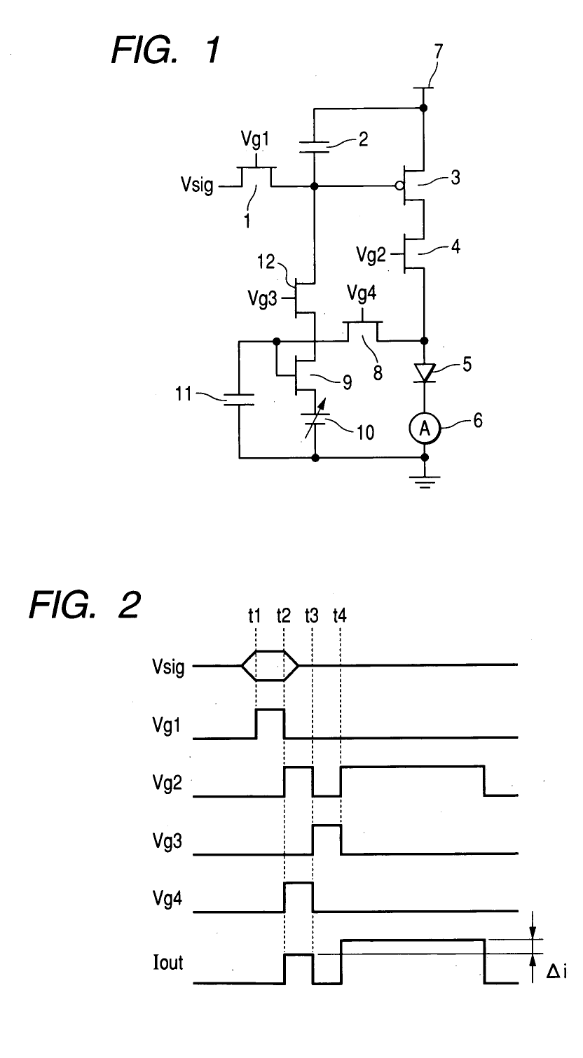

FIG. 1 shows a pixel circuit of an embodiment of a display element of the invention. As a load, a light-emitting element 5 is used. In the figure, reference numerals 1, 3, 4, 8, 9 and 12 denote TFTs. Only the TFT 3 is a p type and the other TFTs are an n type. Reference numerals 2 and 11 denote capacitors; 6, an ammeter; 7, a power supply; and 10, a variable or fixed bias voltage supply. In the figure, the TFT 3 is a drive transistor and the TFT 9 is a second transistor. The ammeter 6 is unnecessary in an actual drive circuit.

A drive circuit for the load of this embodiment is a voltage programming type. An input signal according to a voltage corresponding to a display luminance is applied to each pixel circuit as a display signal Vsig. An operation of the pixel will be explained according to a timing chart of FIG. 2.

The display signal Vsig corresponding to a luminance of display in the next frame is inputted to an input terminal of an n-channel TFT 1 serving as a transistor for address. At decided time t1, a gate voltage Vg1 of the TFT 1 serving as the transistor for address rises to H, the TFT 1 is turned ON, a charge corresponding to a voltage value of the display signal is accumulated in a storage capacitor 2, and a gate of the p-channel TFT 3 serving as the transistor for drive has a potential corresponding to the display signal.

At time t2, Vg1 falls to L and the TFT 1 is turned OFF and, at the same time, Vg2 rises to H and the TFT 4 serving as a switching transistor is turned ON. Consequently, the TFT 3 supplies a current (display current Iout) of a value corresponding to a gate potential to the light-emitting element 5 via the TFT 4. In addition, at the time t2, Vg4 also rises to H and the TFT 8 serving as a second switching transistor is turned ON, and a gate potential of the TFT 9 serving as a transistor for correction is equal to an input terminal (anode) potential of the light-emitting element 5. Here, if a source of the TFT 9 is set to a value found by deducting (a threshold value of the TFT 9 from an anode potential of the light-emitting element 5 with respect to a display current), that is, when a predetermined potential is defined as Ps, an anode terminal potential of a light-emitting element with respect to a drive current is defined as Pi, and a threshold voltage of the transistor for correction 9 is defined as Vth, a relation among Ps, Pi and Vth is set as Ps=Pi−Vth, a source potential of the transistor for correction is set to the predetermined potential Ps. Consequently, an amount of a voltage increased by deterioration can be extracted as a source-to-drain current (correction signal) of the TFT 9.

In this way, after the sour-drain current of the TFT 9 is decided, Vg4 is decreased to L to turn off the TFT 8 at time t3 and, at the same time, Vg3 is increased to H to turn ON the TFT 12 serving as a switching transistor, whereby the source-to-drain current of the TFT 9 is fed from the capacitor 2. As a result, a gate potential of the TFT 3 falls, an amount of an electric current supplied to the light-emitting element 5 by the TFT 3 increases (Δi), and the light-emitting element 5 emits light at the same luminance as before the deterioration. Since a relation between the electric current and the luminance is linear, the luminance is corrected according to the relation shown in FIG. 10.

More specifically, in the case of the pixel circuit in which a power supply voltage of the power supply 7 is set to about 10V, a voltage to be inputted and held in the storage capacitor 2 is set to about 7.3V, an output voltage of the variable bias voltage source 10 is set to about 2.5V, and a voltage of about 5V is detected in the capacitor 11, as the pixel circuit continues to be used for a long period of time, a luminance of an organic EL element serving as a light-emitting element falls and a resistance increases, and an anode voltage of the light-emitting element increases accordingly. When the TFT 8 is turned ON to detect the increase of the anode voltage, since a voltage of about 6V is detected in the capacitor 11, the TFT 9 serving as a transistor for correction attempts to feed a current more because a gate voltage of the TFT 9 increases. Thus, when the TFT 12 is turned ON, since the voltage held by the storage capacitor 2 falls to a value lower than 7.3V and the gate voltage of the TFT 3 serving as the transistor for drive falls, the TFT 3 attempts to feed a larger current. In this way, a drive current larger than before the use in the long period of time flows to the organic EL element. Thus, even after the use in the long period, the organic EL element can emit light at the same luminance as before the use.

In this embodiment, a size of the TFT 9 is adjusted to change a gate voltage-drain current characteristic of the TFT, whereby it is possible to multiply the correction signal with a coefficient to change a relation between Vgbias and Vout of a TFT 62 (equivalent to the TFT 9) shown in FIGS. 11 and 12 and keep a luminance according to the voltage-luminance characteristic shown in FIG. 10 constant.

### Second Embodiment

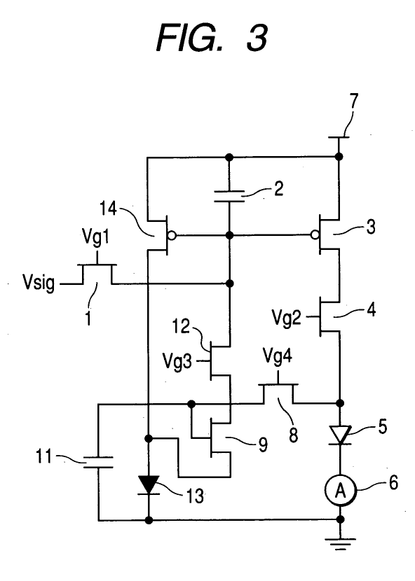

FIG. 3 shows a pixel circuit of a second embodiment of the display element of the invention. In the figure, reference numeral 12 denotes a nonlinear element having a diode characteristic and 14 denotes a p-type TFT. As a load, the light-emitting element 5 is used.

In the pixel circuit of this embodiment, the variable bias voltage 10 of the pixel circuit of the first embodiment is changed to a nonlinear element 13 and a current mirror circuit is constituted by the TFT 3 and the TFT 14 serving as the drive transistors. An operation of this pixel circuit will be explained according to a timing chart of FIG. 2.

When a display signal is decided at time t1, Vg1 rises to H and the TFT 1 is turned ON, a charge corresponding to a display signal is accumulated in the capacitor 2, and gate potentials of the TFTs 3 and 14 are set. Subsequently, at time t2, Vg1 falls to L and, at the same time, Vg2 and Vg4 rise to H, and the TFT 1 is turned OFF and the TFTs 4 and 8 are simultaneously turned ON. As a result, an electric current corresponding to the display signal is supplied to the light-emitting element 5 and the gate of the TFT 9 from the TFT 3 via the TFT 4. Here, an electric current of the same value as the display current supplied to the light-emitting element 5 is also fed to the nonlinear element 13 by a current mirror circuit constituted by the p-type TFTs 3 and 14. Consequently, a bias voltage of the source of the TFT 9 is set to a forward potential (set in advance to a value obtained by subtracting a threshold value of the TFT 9 from an anode potential of the light-emitting element 5 with respect to the display current). In other words, when a predetermined potential is defined as Ps, an anode terminal potential of a light-emitting element with respect to a drive current is defined as Pi, and a threshold voltage of the transistor for correction 9 is defined as Vth, a relation among Ps, Pi and Vth is set as Ps=Pi−Vth, and the diode 13 serving as the nonlinear element is designed such that a source potential of the transistor for correction is a predetermined potential Ps. As a result, an amount of a voltage increased by the deterioration, can be extracted as a source-to-drain current (correction signal) of the TFT 9.

After the source-to-drain current of the TFT 9 is decided, at time t3, Vg4 is decreased to L to turn OFF the TFT 8 and, at the same time, Vg3 is increased to H to turn ON the TFT 12, whereby the source-to-drain current of the TFT 9 is supplied to the capacitor 2. As a result, a gate potential of the TFT 3 falls, an amount of an electric current supplied to the light-emitting element 5 by the TFT 3 increases, and the light-emitting element 5 emits light at the same luminance as before the deterioration. Since a relation between the electric current and the luminance is linear, the luminance is corrected according to the relation shown in FIG. 10.

In this embodiment, it is also possible to multiply the correction signal with a coefficient by adjusting a size of the TFT 9.

### Third Embodiment

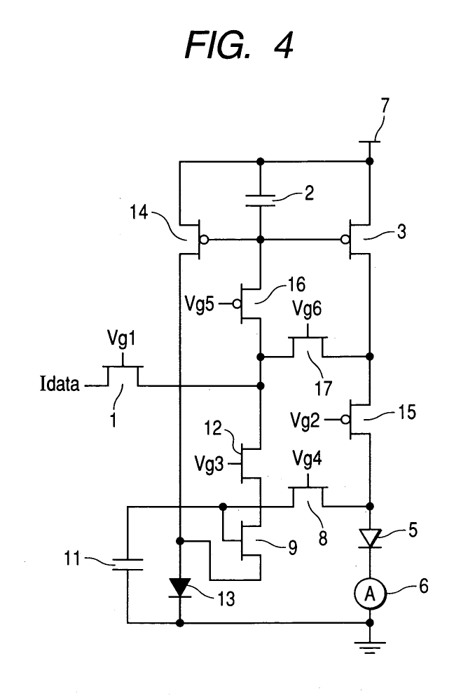

FIG. 4 shows a pixel circuit of a third embodiment of the display element of the invention. In the figure, reference numerals 3, 14, 15 and 16 denote p-type TFTs and 1, 8, 9, 12 and 17 denote n-type TFTs. As a load, the light-emitting element 5 is used.

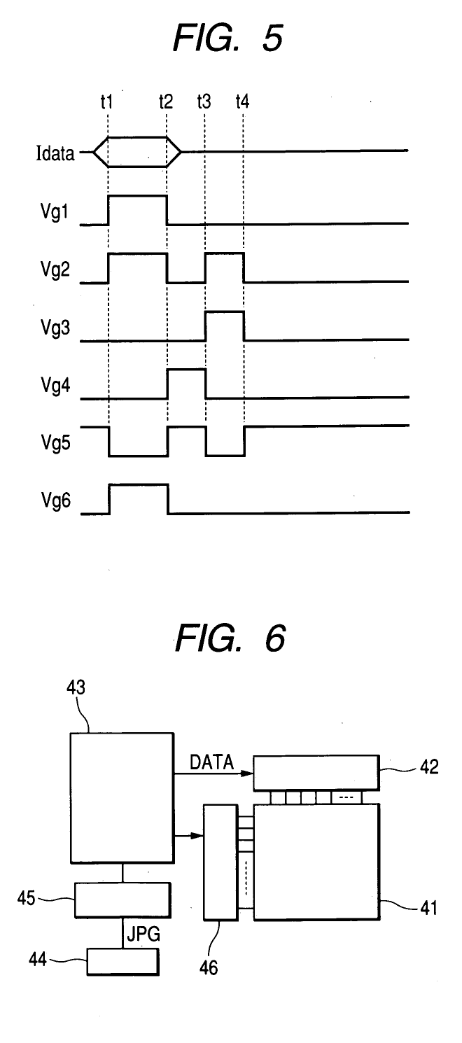

The display element is a current programming type, and a display signal Idata according to a current corresponding to a display luminance is applied to each pixel circuit as an input signal. An operation of the pixel will be explained with reference to a timing chart in FIG. 5.

A display signal corresponding to a luminance of display in the next frame is inputted to an input terminal of the n-channel TFT 1 serving as a transistor for address and, at decided time t1, gate potentials Vg1 and Vg6 of the TFTs 1 and 17 rise to H. At the same time, a gate potential Vg5 of the TFT 16 falls to L, the TFTs 1, 17 and 16 are turned ON and a charge corresponding to a voltage value of the display signal is accumulated in the capacitor 2, and gates of the TFTs 3 and 14 have potentials corresponding to the display signal.

At time t2, Vg1 and Vg6 fall to L and Vg5 rises to H, and the TFTs 1, 17 and 16 are turned OFF. At the same time, Vg2 falls to L and Vg4 rises to H, the TFTs 8 and 15 are turned ON, and an electric current corresponding to the display signal is supplied to the light-emitting element 5 and a gate of the TFT 9 from the TFT 3 via the TFT 15. Here, an electric current of the same value as the display current supplied to the light-emitting element 5 also flows to the nonlinear element 13. Consequently, a bias voltage of the source of the TFT 9 is set to a forward potential (set in advance to a value obtained by subtracting a threshold value of the TFT 9 from an anode potential of the light-emitting element 5 with respect to the display current). In other words, when a predetermined potential is defined as Ps, an anode terminal potential of a light-emitting element with respect to a drive current is defined as Pi, and a threshold voltage of the transistor for correction 9 is defined as Vth, a relation among Ps, Pi and Vth is set as Ps=Pi−Vth, and the diode 13 serving as the nonlinear element is designed such that a source potential of the transistor for correction is a predetermined potential Ps. As a result, an amount of a voltage increased by the deterioration can be extracted as a source-to-drain current (correction signal) of the TFT 9.

At time t3, Vg2 rises to H, Vg4 falls to L, and TFTs 8 and 15 are turned OFF, at the same time, Vg3 rises to H, Vg5 falls to L, and the TFTs 9, 12 and 16 are turned ON. As a result, the source-to-drain current of the TFT 9 flows from the capacitor 2, and gate voltage of the TFT 3 falls.

At time t4, Vg3 falls to L, Vg5 rises to H, and the TFTs 12 and 16 are turned OFF and, at the same time, Vg2 falls to L and the TFT 15 is turned ON, an electric current obtained by adding a correction signal of an amount of the deterioration to the display current flows to the light-emitting element 5, and the light-emitting element 5 emits light at the same luminance as before the deterioration. Since a relation between the electric current and the luminance is linear, the luminance is corrected according to the relation shown in FIG. 10.

In this embodiment, it is also possible to multiply the correction signal with a coefficient by adjusting a size of the TFT 9.

As in the respective embodiments described above, the TFTs 8 and 12 serving as the switching transistors are turned ON for each predetermined period, for example, a period of one frame or a period of several frames, an impedance of a load (which can also be regarded as a resistance or an anode voltage) is detected, and a drive current is corrected on the basis of the impedance, whereby it is possible to drive the load with an electric current necessary for causing a desired phenomenon. A typical example of the embodiments is a pixel circuit using an organic EL element.

### Fourth Embodiment

An image forming apparatus of this embodiment shown in FIG. 6 uses a large number of the pixel circuits in the first to the third embodiments described above. The pixel circuit group is arranged in a two-dimensional matrix shape, and the image forming apparatus includes a display unit 41 for forming an image in the pixel circuit group according to light emission of the light-emitting element. In addition, a line drive circuit 42 supplies an image signal (Vsig or Idata) to the pixel circuit group. The display unit 41 is controlled to be driven by the line drive circuit 42 and a row selection circuit 46. Preferably, an image data supply circuit 43 that supplies analog or digital image data DATA to the line drive circuit 42 can perform image processing such as contrast adjustment, gamma adjustment, sharpness adjustment, and scaling. Moreover, the image forming apparatus includes a decoder 45 that decodes compressed image data JPG stored in a storage medium 44 and supplies the decoded image data to the image data supply circuit 43. This image forming apparatus is used as a TV receiver, a digital camera, or a monitor of a digital video camera recorder suitably.

### Fifth Embodiment

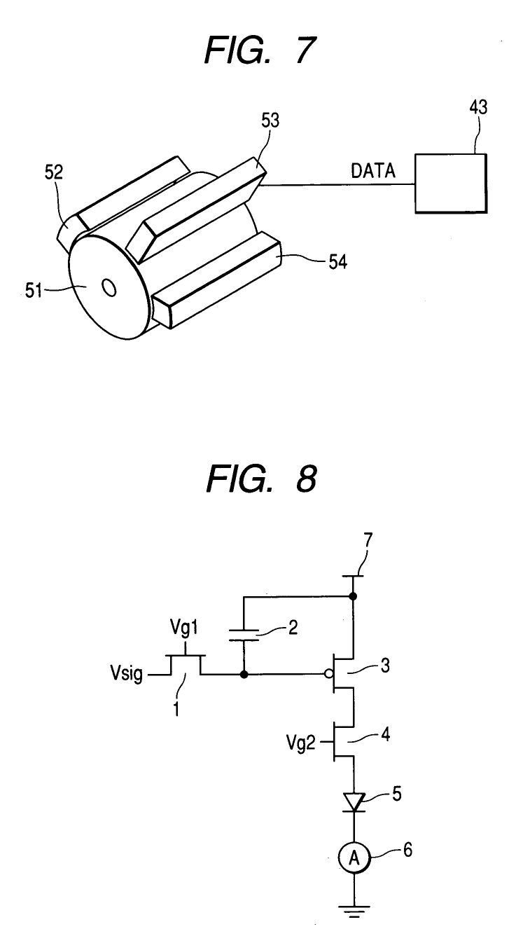

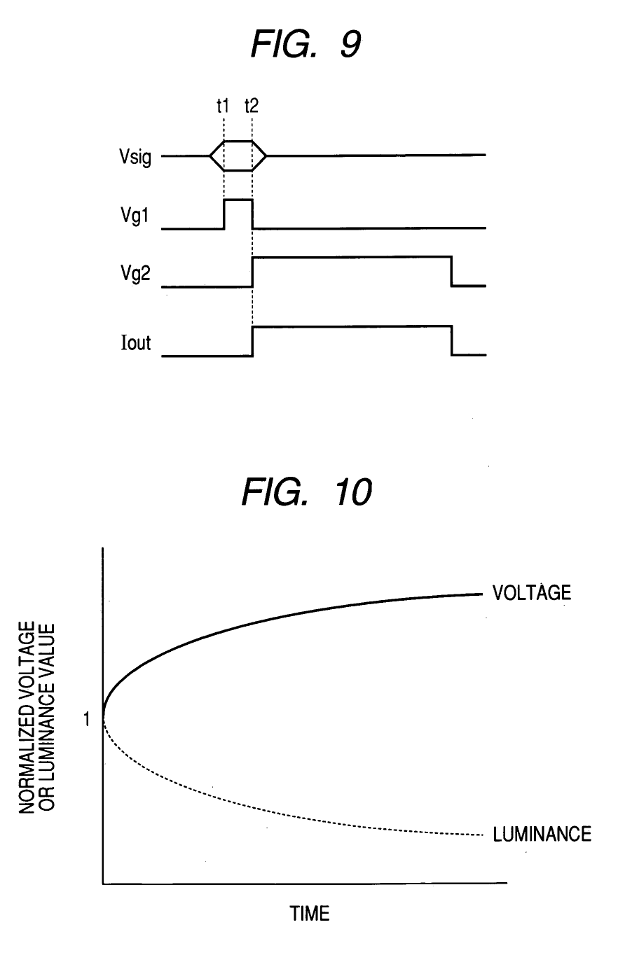

An image forming apparatus of this embodiment shown in FIG. 7 uses a large number of the pixel circuits of the first to the third embodiments described above. The pixel circuit group is arranged at least in a one-dimensional matrix shape and constitutes a light-emitting element array. This image forming apparatus is a printer of an electrophotographic system and includes a photosensitive member 51, a charging device 52 for charging the photosensitive member 51, and an exposing device 53 for forming a latent image on the photosensitive member 51 according to light emission of the light-emitting element. The exposing device 53 includes the light-emitting element array.

In addition, this image forming apparatus includes a developing device 54. A not-shown line drive circuit in the exposing device 53 supplies an image signal to the pixel circuit group, the light-emitting element array emits light in synchronization with the image signal, and the photosensitive member 51 rotates. As the image data supply circuit 43 that supplies image data to the line drive circuit, it is possible to use the same image data supply circuit as the fourth embodiment. However, since only a still image is handled in this embodiment, an internal structure of the image data supply circuit 43 is different.

This application claims priority from Japanese Patent Application No. 2004-035295 filed on Feb. 12, 2004, which is hereby incorporated by reference herein.

1. A drive circuit comprising a drive transistor for feeding to a load a drive current corresponding to an input signal, wherein
the drive circuit has a correction circuit that supplies a correction signal corresponding to an impedance of the load to a gate of the drive transistor to correct the drive current to be fed to the load by the drive transistor.

2. The drive circuit according to claim 1, wherein the load is a light-emitting element, and the drive circuit feeds an electric current to the light-emitting element, detects a voltage between both terminals of the light-emitting element to detect an impedance of the light-emitting element, and performs the correction on the basis of a result of the detection.

3. The drive circuit according to claim 1, wherein the load is a light-emitting element, one terminal of the light-emitting element is connected to a gate of a transistor for correction, and when a predetermined potential Ps is set to a value calculated by deducting a threshold voltage Vth of the transistor for correction from a terminal potential Pi of the light-emitting element with respect to a drive current, the drive circuit sets a source potential of the transistor for correction to the predetermined potential Ps to thereby generate a voltage corresponding to an impedance of the light-emitting element as a source-to-drain current of the transistor for correction.

4. The drive circuit according to claim 3, wherein the drive circuit inputs the source-to-drain current of the transistor for correction to the gate of the drive transistor as the correction signal.

5. The drive circuit according to claim 3, wherein the drive circuit sets the source potential of the transistor for correction using a nonlinear element having a variable bias voltage or diode characteristic.

6. The drive circuit according to claim 3, wherein it is possible to multiply the correction signal with a coefficient according to a setting for a size of the transistor for correction.

7. An image forming apparatus comprising: a pixel circuit group in which plural pixel circuits, which include a light-emitting element and a drive transistor for feeding a drive current corresponding to an input signal to the light-emitting element, are arranged, wherein
each of the pixel circuits has a correction circuit that supplies a correction signal corresponding to an impedance of a load to a gate of the drive transistor and corrects the drive current to be fed to the light-emitting element by the drive transistor.

8. The image forming apparatus according to claim 7, wherein the light-emitting element is an organic electroluminescent element.

9. The image forming apparatus according to claim 8, wherein
the pixel circuit group is arranged in a two-dimensional matrix shape, and
the image forming apparatus includes:
a display unit that forms an image in the pixel circuit group according to light emission of the light-emitting element;
a line drive circuit that supplies an image signal to the pixel circuit group;
an image data supply circuit that supplies image data to the line drive circuit; and
a decoder that decodes compressed image data stored in a storage medium and supplies the decoded image data to the image data supply circuit.

10. The image forming apparatus according to claim 8, further comprising:
a photosensitive member;
a charging device for charging the photosensitive member; an exposure device that has the pixel circuit group arranged at least in a one-dimensional matrix shape and is used for forming a latent image on the photosensitive member according to light emission of the light-emitting element;
a developing device;
a line drive circuit that supplies an image signal to the pixel circuit group; and
an image data supply circuit that supplies image data to the line drive circuit.

11. A drive circuit comprising a drive transistor for feeding a drive current corresponding to an input signal to a load, wherein
the drive circuit has a correction circuit that supplies a correction signal corresponding to an amount of deterioration of the load to a gate of the drive transistor to correct the drive current to be fed to the load by the drive transistor.

12. A drive circuit comprising:
a drive transistor for feeding a drive current corresponding to an input signal to a load;
a storage capacitor that is connected to a control electrode of the drive transistor and used for retaining an input signal;
a detection circuit for detecting a resistance of the load; and
a correction circuit that feeds back a result of the detection by the detection circuit to the drive transistor to correct a drive current to be fed to the load by the drive transistor.

13. The drive circuit according to claim 12, wherein
the detection circuit includes a second capacitor that is connected to a terminal, which is connected to the load, via a switching transistor, and
the correction circuit includes a transistor for correction that has a control electrode connected to the second capacitor and is used for changing a potential of the control electrode of the drive transistor.

14. An image forming apparatus comprising a pixel circuit group in which plural pixel circuits, which include a light-emitting element serving as a load and the drive circuit according to claim 12, are arranged, wherein
the pixel circuit group is arranged in a two-dimensional matrix shape, and
the image forming apparatus includes: a display unit that forms an image in the pixel circuit group according to light emission of the light-emitting element;
a line drive circuit that supplies an image signal to the pixel circuit group;
an image data supply circuit that supplies image data to the line drive circuit; and
a decoder that decodes compressed image data stored in a storage medium and supplies the decoded image data to the image-data supply circuit.

15. An image forming apparatus comprising a pixel circuit group in which plural pixel circuits, which include a light-emitting element serving as a load and the drive circuit according to claim 12, are arranged, comprising:
a photosensitive member;
a charging device for charging a photosensitive member;
an exposing device that has the pixel circuit group arranged at least in a one-dimensional matrix shape and is used for forming a latent image on a photosensitive member according to light emission of the light-emitting element;
a developing device;
a line drive circuit that supplies an image signal to the pixel circuit group; and
an image data supply circuit that supplies image data to the line drive circuit.
